(19) United States
(12) Patent Application Publication
(10) Pub. No.: US 2009/0173516 A1
(43) Pub. Date: Jul. 9, 2009

(54) NANOTUBES AS MICROWAVE FREQUENCY INTERCONNECTS

(76) Inventors: Peter J. Burke, Irvine, CA (US); Zhen Yu, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/379,759

(22) Filed: Apr. 21, 2006

Related U.S. Application Data
(60) Provisional application No. 60/673,955, filed on Apr. 22, 2005.

(51) Int. Cl. H01B 5/00; H01R 43/00

(52) U.S. Cl. 174/126.1; 29/825; 977/750

(57) ABSTRACT

The present invention provides nanotube interconnects capable of carrying current at high frequencies for use as high-speed interconnects in high frequency circuits. It is shown that the dynamical or AC conductance of single-walled nanotubes equal their DC conductance up to at least 10 GHZ, demonstrating that the current carrying capacity of nanotube interconnects can be extended into the high frequency (microwave) regime without degradation. Thus, nanotube interconnects can be used as high-speed interconnects in high frequency circuits, e.g., RF and microwave circuits, and high frequency nano-scale circuits. In a preferred embodiment, the nanotube interconnects comprise metallic single-walled nanotubes (SWNTs), although other types of nanotubes may also be used, e.g., multi-walled carbon nanotubes (MWNTs), ropes of all metallic nanotubes, and ropes comprising mixtures of semiconducting and metallic nanotubes. Applications for the nanotube interconnects include both digital and analog electronic circuitry.

### RELATED APPLICATION INFORMATION

This application claims the benefit of U.S. Provisional Application No. 60/673,955, filed on Apr. 22, 2005.

### GOVERNMENT INFORMATION

This invention was made with Government support under Grant No. N66001-03-1-8914, awarded by the Office of Naval Research. The Government has certain rights in this invention.

### FIELD OF THE INVENTION

The present invention relates to nanotubes and, more particularly, to the use of nanotubes to carry currents and voltages at high frequencies.

### BACKGROUND

Nanotubes are commonly made from carbon and comprise graphite sheets seamlessly wrapped into cylinders. Nanotubes can be single-walled or multi-walled. Single-walled nanotubes (SWNTs) comprise single cylinders and represent nearly ideal one dimensional electronic structures. Multi-walled nanotubes (MWNTs) comprise multiple cylinders arranged concentrically. Typical dimensions are 1-3 nm for SWNTs and 20-100 nm for MWNTs.

Nanotubes can be either metallic or semiconducting depending on their structure. Metallic nanotubes are non-gateable, meaning that their conductance does not change with applied gate voltages, while semiconducting nanotubes are gateable. The electrically properties of nanotubes make them promising candidates for the realization of nanoscale electronic devices smaller than can be achieved with current lithographic techniques.

Nanotube transistors are predicted to be extremely fast, especially if the nanotubes can be used as the interconnects themselves in future integrated nanosystems. The extremely high mobilities found in semiconducting nanowires and nanotubes are important for high speed operations, one of the main predicted advantages of nanotube and nanowire devices in general. Nanotubes may also have a role to play as high frequency interconnects in the long term between active nanotube transistors or in the short term between conventional transistors because of their capacity for large current densities.

Early theoretical work predicted significant frequency dependence in the nanotube dynamical impedance in the absence of scattering and contact resistance. The origin of this predicted frequency dependence is in the collective motion of the electrons, which can be thought of as one dimensional plasmons. Our equivalent circuit description shows that the nanotube forms a quantum transmission line, with distributed kinetic inductance and both quantum and geometric capacitance. In the absence of damping, standing waves on this transmission line can give rise to resonant frequencies in the microwave range (1-10 GHz) for nanotube lengths between 10 and 100 mm. We also proposed an ad-hoc damping model, relating the damping to the dc resistance per unit length. To date, there have been no measurements of the microwave frequency conductance of a SWNT.

### SUMMARY

The present invention provides nanotube interconnects capable of carrying current and voltage at high frequencies for use as high-speed interconnects in high frequency circuits.

It is shown that the dynamical or AC conductance of single-walled nanotubes equal their DC conductance up to at least 10 GHz, demonstrating that the current carrying capacity of nanotube interconnects can be extended into the high frequency (microwave) regime without degradation. Thus, nanotube interconnects can be used as high-speed interconnects in high frequency circuits, e.g., RF and microwave circuits, and high frequency nanoscale circuits. In a preferred embodiment, the nanotube interconnects comprise metallic single-walled nanotubes (SWNTs), although other types of nanotubes may also be used, e.g., multi-walled carbon nanotubes (MWNTs), ropes of all metallic nanotubes, and ropes comprising mixtures of semiconducting and metallic nanotubes.

The nanotube interconnects are advantageous over copper interconnects currently used in integrated circuits. Nanotube interconnects have much higher conductivity than copper interconnects, and do not suffer from surface scattering, which can further reduce the conductivity of copper interconnects as dimensions are decreased below 100 nm. The higher conductivity of nanotube interconnects in addition to their demonstrated high frequency current carrying capacity make them advantageous over copper interconnects for high-speed applications, including high frequency nanoscale circuits.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE FIGURES

FIG. 1 is a graph showing current-voltage characteristics for a device A, a single-wall nanotube (SWNT) with a 1 μm electrode spacing.

FIG. 2 is a graph showing the conductance versus source-drain voltage for device A at frequencies of DC, 0.6 GHz, and 10 GHz.

FIG. 3 is a graph showing current-voltage characteristics for a device B, a SWNT with an a 25 μm electrode spacing.

FIG. 4 is a graph showing the conductance versus source-drain voltage for device B at frequencies of DC, 0.3 GHz, 1 GHz, and 10 GHz.

### DETAILED DESCRIPTION

The present invention provides nanotube interconnects capable of carrying current and voltage at high frequencies for use as high-speed interconnects in high frequency circuits. The current and voltage carrying capacity of nanotube interconnects at high frequencies is demonstrated by the measurements below.

The first measurements of the high frequency conductance of a single-walled nanotube (SWNT) are presented. We find experimentally that the ac conductance is equal to the dc conductance up to at least 10 GHz. This clearly demonstrates for the first time that the current carrying capacity of carbon nanotubes can be extended without degradation into the high frequency (microwave) regime.

In our experimental results, no clear signatures of Tomonaga-Luttinger liquid behavior are observed (in the form of non-trivial frequency dependence) and no specifically quantum effects (reflecting quantum versus classical conductance of nanotubes) are reported, in contradiction to theoretical predictions for ac conductance in 1d systems that neglect scattering¹⁰. In order to explain this discrepancy between theory (which neglects scattering) and experiment (which includes realistic scattering), we present a phenomenological model for the finite frequency conductance of a carbon nanotube which treats scattering as a distributed resistance. This model explains why our results at ac frequencies do not display frequency dependence. Simply put, resistive damping washes out the predicted frequency dependence.

Individual SWNTs¹³ were synthesized via chemical vapor deposition^{14,15} on oxidized, high-resistivity p-doped Si wafers (ρ>10 kΩ-cm) with a 400-500 nm SiO₂ layer. Metal electrodes were formed on the SWNTs using electron-beam lithography and metal evaporation of 20-nm Cr/100 nm Au bilayer. The devices were not annealed. Nanotubes with electrode spacing of 1 (device A) and 25 μm (device B) were studied. Typical resistances were ˜MΩ; some nanotubes had resistances below 250 kΩ. In this study we focus on metallic SWNTs (defined by absence of a gate response) with resistance below 200 kΩ. Measurements were performed at room temperature in air.

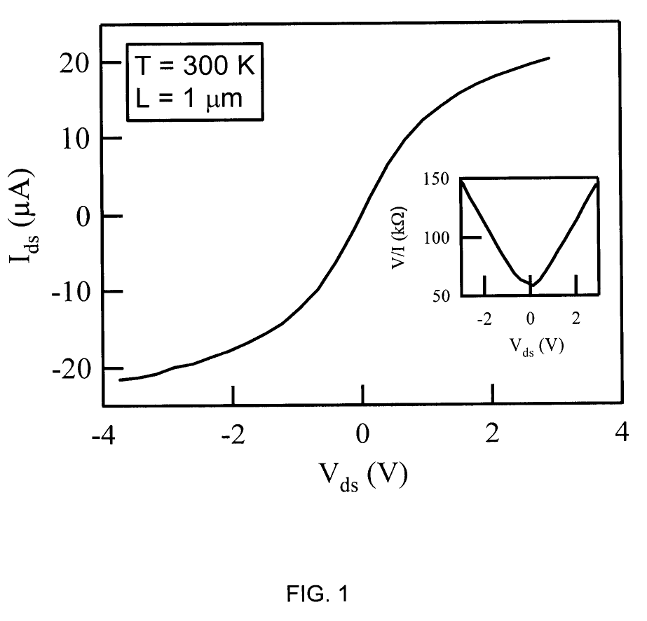

FIG. 1 shows the room temperature I-V characteristic of device A, a SWNT with a 1 μm electrode spacing. Since this length is comparable to the mean-free-path for electrons, this device is in the quasi-ballistic limit. The low-bias resistance of this device was 60 kΩ. This resistance is most likely dominantly due to the contact; at low fields, once electrons are injected transport is quasi-ballistic from source to drain. The device clearly shows saturation in the current at around 20 μA. The inset shows that (over almost the entire range of applied voltage) the absolute resistance (V/I) can be described by a simple function

V/I=R₀+|V|/I₀ Equation (1)

where R₀ and I₀ are constants, as was originally found and explained by Yao¹⁶. From the slope of the linear part of the R-V curve, we find I₀=29 μA for this device, in good agreement with Yao¹⁶. There, it was shown that the saturation behavior is due to a modified mean-free-path for electrons when the electric field is sufficient to accelerate electrons to a large enough energy to emit an optical phonon. This effect was studied more quantitatively with similar conclusions in^{17,18}.

In order to measure the dynamical impedance at microwave frequencies, a commercially available microwave probe (suitable for calibration with a commercially available open/short/load calibration standard) allowed for transition from coax to lithographically fabricated on chip electrodes. The electrode geometry consisted of two small contact pads, one 50×50 μm², and the other 200×200 μm² (for device A) or 50×200 μm² (for device B). A microwave network analyzer is used to measure the calibrated (complex) reflection coefficient S₁₁(ω)≡V_{reflected}/V_{incident}, where V_{incident} is the amplitude of the incident microwave signal on the coax, and similarly for V_{reflected}. This is related to the load impedance Z(ω) by the usual reflection formula: S₁₁=[Z(ω)−50Ω]/[Z(ω)+50Ω]. At the power levels used (3 μW), the results are independent of the power used.

The statistical error in the measurement of both the Re(S₁₁) and Im(S₁₁) due to random noise in the network analyzer is less than 1 part in 10⁴. A systematic source of error in the measurement due to contact-to-contact variation and non-idealities in the calibration standard gives rise to an error of 2 parts in 10³ in the measurement of Re(S₁₁) and Im(S₁₁). Because the nanotube impedance is so large compared to 50Ω, these errors will be important, as we discuss in more depth below.

We measure the value of S₁₁ as a function of frequency and source-drain voltage for both device A and B. While the absolute value of S₁₁ is found to be 0±0.02 dB over the frequency range studied (the systematic error due to contact-to-contact variation), small changes in S₁₁ with the source-drain voltage are systematic, reproducible, and well-resolved within the statistical error of ±0.0005 dB. The change in S₁₁ with source-drain voltage is not an artifact, since control samples do not exhibit this effect. Our measurement clearly shows that the value of S₁₁, and hence the nanotube dynamical impedance, depends on the dc source-drain bias voltage, and that this dependence is independent of frequency over the range studied for both devices.

For both device A and B, we find Im(S₁₁)=0.000±0.002, indicating that the nanotube impedance itself is dominantly real. Our measurement system is not sensitive to imaginary impedances much smaller than the real impedance, which is of order 100 kΩ. For all measurements presented here, Im(S₁₁) does not change with V_{ds} within the statistical uncertainty of 1 part in 10⁴. On the other hand, Re(S₁₁) changes reproducibly with V_{ds}, indicating that the real part of the nanotube dynamical impedance changes with V_{ds}.

By linearizing the relationship between S₁₁ and the conductance G, it can be shown that for small values of G (compared to 50Ω), G(mS)≈1.1×S₁₁ (dB). (We note that after calibration, a control experiment with no nanotube gives 0±0.02 dB, where the uncertainty is due to variations in the probe location on the contact pads from contact to contact.) Based on this calculation, we conclude that the absolute value of the measured high frequency conductance is found to be 0 with an error of ±22 μS, which is consistent with the dc conductance.

In order to analyze the data more quantitatively, we concentrate on the change in S₁₁ with V_{ds}. The measurement error on the change in the ac conductance G with bias voltage depends primarily on the statistical uncertainty in S₁₁, which in our experiments is 20 times lower than the systematic error. (Since the contact probe remains fixed in place while changing the gate voltage, we can reproducibly and reliable measure small changes in S₁₁ with the source-drain voltage.) Thus, although the absolute value of G can only be measured with an uncertainty of 20 μS, a change in G can be measured with an uncertainty of 1 μS. These uncertainties are a general feature of any broadband microwave measurement system.

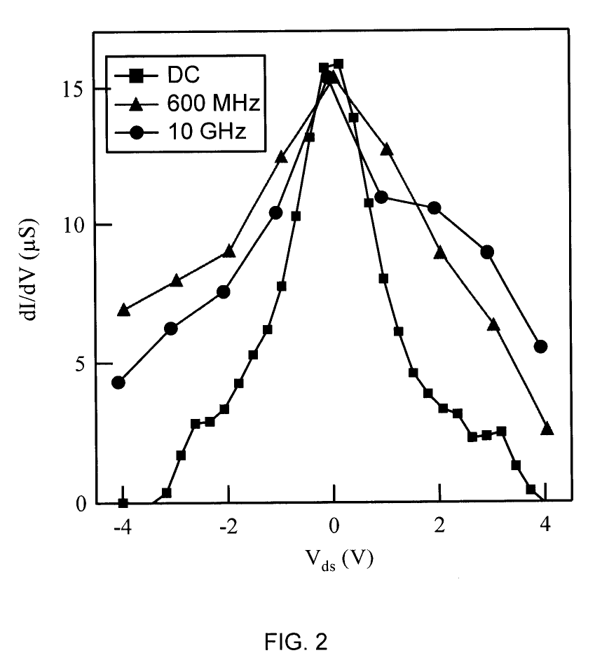

FIG. 2 plots the conductance G vs. the source-drain voltage for device A at dc, 0.6 GHz, and 10 GHz. We only know the change in G with V_{ds}, so we add an offset to G_{ac} to equal G_{dc} at V_{ds}=0. We discuss this in more detail below, but at the moment it is clear that the G at ac changes with V_{ds} just as it does at dc. We now discuss the offset.

Based on the measured results we know the absolute value of G is between 0 and 22 μS; based on FIG. 2 we know that G changes by 10 μS when V_{ds} changes by 4 V. The dynamical conductance is probably not negative (there is no physical reason for this to be the case), which allows the following argument to be made: Since G_{ac}(V_{ds}=0)−G_{ac}(V_{ds}=4V)=10 μS (measured), and G_{ac}(V_{ds}=4V)>0 (on physical grounds), therefore G_{ac}(V_{ds}=0V)>10 μS; our measurements put this as a lower limit; the upper limit would be 20 μS. Therefore, our measurements show for the first time that, within 50%, nanotubes can carry microwave currents and voltages just as efficiently as dc currents and voltages.

Because device A is in the quasi-ballistic limit, but does not approach the theoretical lower limit of 6 kΩ for perfect contacts, the metal-nanotube contact resistance probably dominates the total resistance for this sample. In order to focus more heavily on the nanotube resistance itself, we turn now to device B.

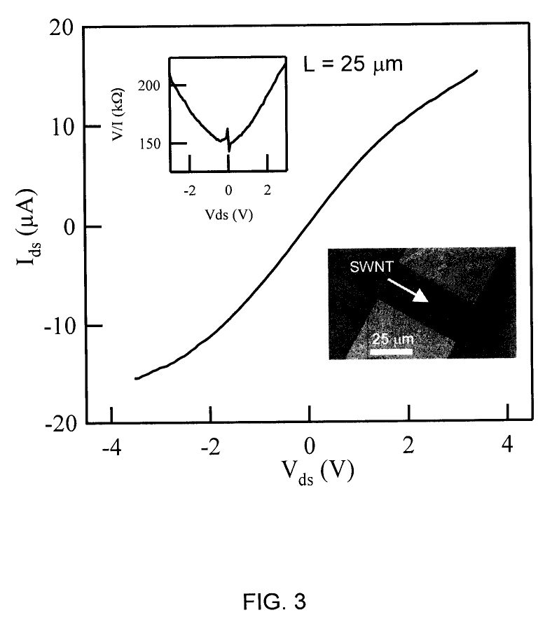

FIG. 3 plots the I-V curve of a longer SWNT (device B), with an electrode gap of 25 μm. (The original length of this nanotube was over 200 μm.) This device is almost certainly not in the ballistic limit, even for low-bias conduction, since the mean-free-path is of order 1 μm^{15,17,18} and the SWNT length is 25 μm. The low-bias resistance of this device is 150 kΩ. Previous measurements in our lab¹⁵ on 4 mm long SWNTs gave a resistance per unit length of 6 kΩ/μm, indicating that the SWNT bulk resistance is about 150 kΩ for device B, and that the contact resistance is small compared to the intrinsic nanotube resistance. The absolute resistance (V/I) and the source-drain I-V curve for this device is well-described by Equation (1), as for device A. We find I₀=34 μA for this device, in agreement with device A.

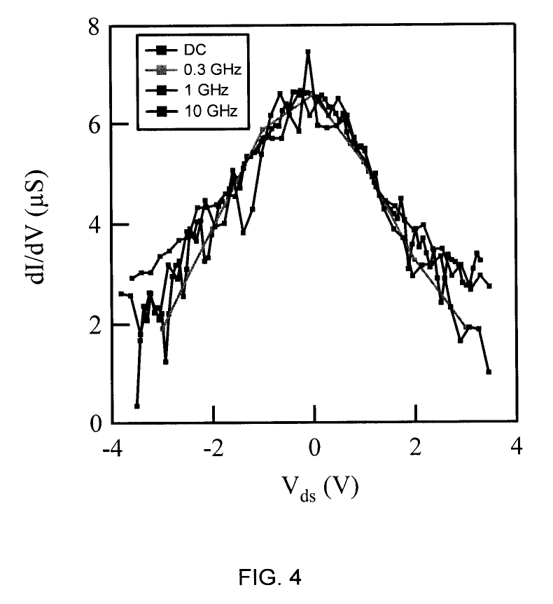

FIG. 4 plots the conductance G vs. the source-drain voltage for device B at dc, 0.3 GHz, 1 GHz, and 10 GHz. As for device A, we only know the change in G with V_{ds}, so we add an offset to G_{ac} to equal G_{dc} at V_{ds}=0. It is clear from this graph that the nanotube dynamical conductance changes with bias voltage just as the dc conductance does. Using similar arguments as for device A, our measurements for device B show that the ac and dc conductance are equal within 50% over the entire frequency range studied.

We now turn to a discussion of our results. At DC, the effects of scattering on nanotubes have been well-studied¹⁶⁻¹⁸. The dc resistance is given by¹⁹

$${R}_{d c} = \frac{h}{4 {e}^{2}} \frac{{L}_{nanotube}}{{l}_{m . f . p .}} , \qquad Equation ( 2 )$$

where I_{m.f.p.} is the mean-free-path. In ballistic systems, the sample contact resistance dominates and the dc resistance has a lower limit given by h/4e²=6 kΩ, which is possible only if electron injection from the electrodes is reflectionless. Is Equation (2) true at finite frequencies? The answer to this question in general is not known.

For the simple case of an ohmically contacted nanotube of length L, we have predicted the first resonance would occur at a frequency given by v_{F}/(4 Lg), where v_{F} is the Fermi velocity, L the length, and g the Luttinger liquid “g-factor”, a parameter which characterizes the strength of the electron-electron interaction. Typically, g˜0.3. For L=25 μm, the first resonance in the frequency dependent impedance would occur at 24 GHz, beyond the range of frequencies studied here. However, our nanotube for device B was originally over 200 μm long. After deposition of electrodes, the nanotube extended under the two electrodes for a distance of at least 150 μm on one side, and 50 μm on the other. If these segments of the nanotube were intact, it would correspond to plasmon resonances at frequencies of 4 and 8 GHz. We clearly do not observe any strong resonant behavior at these or any other frequencies. We believe this must be due to the damping of these plasmons, as we discuss below.

While this is not justified rigorously, we assume that Equation (2) describes a distributed resistance of the nanotube that is independent of frequency, equal to the measured dc resistance per unit length of 6 kΩ/μm of similar long nanotubes grown in our lab¹⁵. In our previous modeling work¹¹, we found that (under such heavy damping conditions) the nanotube dynamical impedance is predicted to be equal to its dc resistance for frequencies less than 1/(2πR_{dc}Cₜₒₜₐₗ), where Cₜₒₜₐₗ is the total capacitance of the nanotube (quantum and electrostatic). Although our measurements presented here are on top of a poorly conducting ground plane (high resistivity Si), and the previous modeling work was for a highly conducting substrate, we can use the modeling as a qualitative guide. For device B, we estimate Cₜₒₜₐₗ=1 fF, so that the ac impedance would be predicted to be equal to the dc resistance for frequencies below about ˜1 GHz. This is qualitatively consistent with what we observe experimentally.

At high bias voltages, the electrons have enough energy to emit optical phonons, dramatically reducing the mean-free-path and modifying Equation (2) to the more general Equation (1). Our measurements clearly show that Equation (1) is still valid up to 10 GHz. A theoretical explanation for this is lacking at this time, although it is intuitively to be expected for the following reason: the electron-phonon scattering frequency in the high-bias region is approximately 1 THz¹⁸. Therefore, on the time-scale of the electric field period, the scattering frequency is instantaneous. Further theoretical work is needed to clarify this point.

Measurements up to higher frequencies of order the electron-phonon scattering rate (˜50 GHz at low electric fields¹⁸) should allow more information to be learned about electron-phonon scattering in nanotubes; temperature dependent measurements would allow for more information as well, such as the intrinsic nanotube impedance at low scattering rates.

Therefore, it has been verified experimentally that the dynamical impedance of metallic SWNTs are dominantly real and frequency independent from dc to at least 10 GHz. As a result, the high current carrying capacity of metallic SWNTs does not degrade into the high frequency (microwave) regime allowing SWNTs to be used as high-speed interconnects in high-speed applications. In the preferred embodiment, the nanotube interconnects comprise metallic SWNTs, although other types of nanotubes may also be used, e.g., MWNTs, ropes of all metallic nanotubes, and ropes comprising mixtures of semiconducting and metallic nanotubes. Metallic SWNTs can have a very high current density (of order 10⁹ A/cm²). A metallic SWNT of order 1-3 nm in diameter can carry currents and voltages of up to 25 μA or higher.

Therefore, nanotube interconnects can be used as high-speed interconnects in a variety of high frequency applications. For example, nanotube interconnects can be used to provide high-speed interconnects in computer processors operating at high clock frequencies of 1 GHz or higher. Nanotubes interconnects can also be used to provide high-speed interconnects in radio frequency (RF) and microwave circuits operating at frequencies up to 10 GHz or higher such as in cellular phones and wireless network systems. The nanotube interconnects can be used to interconnect active devices (e.g., transistors), passive devices, or a combination of active and passive devices in circuits operating at high frequencies in the GHz range. The nanotube interconnects can also be used to interconnect nanoscale devices to realize high frequency all nanotube circuits. For example, the nanotube interconnects can be used to interconnect nanotube field effect transistors (FETs), in which semiconducting nanotubes are used for the channels of the nanotube FETs. The nanotube interconnects can also be used to interconnect lager-scale devices, e.g., conventional transistors, for high-speed applications or to interconnect a combination of nanoscale and larger-scale devices in a circuit. A nanotube interconnect can comprise a single nanotube or comprise more than one nanotube arranged in parallel in an N-array, where N is the number of nanotubes.

The invention also provides a useful method for modeling nanotube interconnects in circuit simulation programs used for designing high frequency circuits. In an embodiment, a circuit simulation program models the dynamical impedance of nanotube interconnects in high frequency circuits as being equal to their de resistance. In other words, the circuit simulation program assumes that the dc resistance of the nanotube interconnect dominates at high frequencies and that the dynamical impedance is not sensitive to imaginary impedances (inductances and capacitances).

The nanotube interconnects are advantageous over copper interconnects currently used in integrated circuits. When scaled by the diameter of 1.5 nm, the resistance per unit length of a nanotube we measure gives a resistivity conductivity of 1 μΩ-cm, which is lower than that of bulk copper. In addition, copper interconnects typically suffer increased surface scattering as the dimensions are decreased below 100 nm, so that even the bulk conductivity of copper is not realized at that length scale. In addition, the current density of carbon nanotubes exceeds that of copper. Thus, per unit width, carbon nanotubes are superior materials to copper as interconnects in integrated circuits.

Our equivalent circuit description shows that the nanotube forms a quantum transmission line, with distributed kinetic inductance and both quantum and geometric capacitance. The kinetic inductance for an individual nanotube is about 4 nH/μm. Numerically this gives rise to an inductive impedance of iωL, where L is the inductance. However, the resistance per unit length is about 6 kΩ/μm. This means that the resistive impedance will dominate the inductive impedance at frequencies below about 200 GHz for a single walled nanotube. Therefore, when considering the applications of nanotubes as interconnects at microwave frequencies, the resistance should be the dominant consideration.

However, the conductivity of nanotubes is larger than copper. Arraying nanotubes allows for wiring with less resistance per unit length than copper of the same total cross sectional area. In addition, the kinetic inductance of an N-array of nanotubes is N times lower than the kinetic inductance of an individual nanotube.

In sum, for nanotubes resistance is the dominate circuit component (as opposed to inductance), and this resistance is smaller than copper wires of the same dimensions. Therefore kinetic inductance is not a major “show-stopper” for the use of nanotubes as interconnects. In addition, there is no cross-talk between nanotubes due to kinetic inductance. This is in contrast to magnetic inductance in copper, which induces cross-talk. Therefore, considering all these factors, carbon nanotubes is superior to copper in all aspects of circuit performance.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

### REFERENCES

¹ P. L. McEuen, M. S. Fuhrer, and H. K. Park, “Single-walled carbon nanotube electronics,” Ieee T Nanotechnol 1 (1), 78-85 (2002).
² M. Bockrath, D. H. Cobden, J. Lu, A. G. Rinzler, R. E. Smalley, T. Balents, and P. L. McEuen, “Luttinger-liquid behaviour in carbon nanotubes,” Nature 397 (6720), 598-601 (1999); M. P. A. Fisher and L. I. Glazman, in Mesoscopic Electron Transport, edited by Lydia L. Sohn, Leo P. Kouwenhoven, Gerd Schèon et al. (Kluwer Academic Publishers, Dordrecht; Boston, 1997).
³ A. Javey, J. Guo, Q. Wang, M. Lundstrom, and H. J. Dai, “Ballistic carbon nanotube field-effect transistors,” Nature 424 (6949), 654-657 (2003).
⁴ H. W. C. Postma, T. Teepen, Z. Yao, M. Grifoni, and C. Dekker, “Carbon nanotube single-electron transistors at room temperature,” Science 293 (5527), 76-79 (2001).
⁵ K. Tsukagoshi, B. W. Alphenaar, and H. Ago, “Coherent transport of electron spin in a ferromagnetically contacted carbon nanotube,” Nature 401 (6753), 572-574 (1999).
⁶ P. J. Burke, “AC Performance of Nanoelectronics: Towards a THz Nanotube Transistor,” Solid State Electronics 40 (10), 1981-1986 (2004); S. Li, Z. Yu, S. F. Yen, W. C. Tang, and P. J. Burke, “Carbon nanotube transistor operation at 2.6 GHz,” Nano Lett 4 (4), 753-756 (2004).
⁷ Y. Cui, Z. H. Zhong, D. L. Wang, W. U. Wang, and C. M. Lieber, “High performance silicon nanowire field effect transistors,” Nano Lett 3 (2), 149-152 (2003).
⁸ T. Durkop, S. A. Getty, E. Cobas, and M. S. Fuhrer, “Extraordinary mobility in semiconducting carbon nanotubes,” Nano Lett 4 (1), 35-39 (2004).
⁹ “International Technology Roadmap for Semiconductors, http://public.itrs.net/,” (2003).
¹⁰ Y. M. Blanter, F. W. J. Hekking, and M. Buttiker, “Interaction constants and dynamic conductance of a gated wire,” Phys Rev Lett 81 (9), 1925-1928 (1998); V. V. Ponomarenko, “Frequency dependences in transport through a Tomonaga-Luttinger liquid wire,” Phys Rev B 54 (15), 10328-10331 (1996); V. A. Sablikov and B. S. Shchamkhalova, “Dynamic conductivity of interacting electrons in open mesoscopic structures,” Jetp Lett+66 (1), 41-46 (1997); G. Cuniberti, M. Sassetti, and B. Kramer, “Transport and elementary excitations of a Luttinger liquid,” J Phys-Condens Mat 8 (2), L21-L26 (1996); G. Cuniberti, M. Sassetti, and B. Kramer, “ac conductance of a quantum wire with electron-electron interactions,” Phys Rev B 57 (3), 1515-1526 (1998); I. Safi and H. J. Schulz, “Transport in an inhomogeneous interacting one-dimensional system,” Phys Rev B 52 (24), 17040-17043 (1995); V. A. Sablikov and B. S. Shchamkhalova, “Dynamic transport of interacting electrons in a mesoscopic quantum wire,” J Low Temp Phys 118 (5-6), 485-494 (2000); R. Tarkiainen, M. Ahlskog, J. Penttila, L. Roschier, P. Hakonen, M. Paalanen, and E. Sonin, “Multiwalled carbon nanotube: Luttinger versus Fermi liquid,” Phys Rev B 64 (19), art. no.-195412 (2001); C. Roland, M. B. Nardelli, J. Wang, and H. Guo, “Dynamic conductance of carbon nanotubes,” Phys Rev Lett 84 (13), 2921-2924 (2000).
¹¹ P. J. Burke, “An RF Circuit Model for Carbon Nanotubes,” Ieee T Nanotechnol 2 (1), 55-58 (2003); P. J. Burke, “Luttinger liquid theory as a model of the gigahertz electrical properties of carbon nanotubes,” Ieee T Nanotechnol 1 (3), 129-144 (2002).
¹² P. J. Burke, I. B. Spielman, J. P. Eisenstein, L. N. Pfeiffer, and K. W. West, “High frequency conductivity of the high-mobility two-dimensional electron gas,” Appl Phys Lett 76 (6), 745-747 (2000).
¹³ M. J. Biercuk, N. Mason, J. Martin, A. Yacoby, and C. M. Marcus, “Anomalous conductance quantization in carbon nanotubes,” Phys Rev Lett 94 (2),—(2005); (Similarly, although it is possible we are measuring small ropes or double walled tubes, most likely we have a single metallic tube. TEM images of nanotubes grown under similar conditions showed only single-walled nanotubes.)
¹⁴ J. Kong, H. T. Soh, A. M. Cassell, C. F. Quate, and H. J. Dai, “Synthesis of individual single-walled carbon nanotubes on patterned silicon wafers,” Nature 395 (6705), 878-881 (1998); Zhen Yu, Shengdong Li, and P. J. Burke, “Synthesis of Aligned Arrays of Millimeter Long, Straight Single Walled Carbon Nanotubes,” Chemistry of Materials 16 (18), 3414-3416 (2004).
¹⁵ Shengdong Li, Zhen Yu, and P. J. Burke, “Electrical properties of 0.4 cm long single walled carbon nanotubes,” Nano Lett 4 (10), 2003-2007 (2004).
¹⁶ Z. Yao, C. L. Kane, and C. Dekker, “High-field electrical transport in single-wall carbon nanotubes,” Phys Rev Lett 84 (13), 2941-2944 (2000).
¹⁷ A. Javey, J. Guo, M. Paulsson, Q. Wang, D. Mann, M. Lundstrom, and H. J. Dai, “High-field quasiballistic transport in short carbon nanotubes,” Phys Rev Lett 92 (10),—(2004).
¹⁸ J. Y. Park, S. Rosenblatt, Y. Yaish, V. Sazonova, H. Ustunel, S. Braig, T. A. Arias, P. W. Brouwer, and P. L. McEuen, “Electron-phonon scattering in metallic single-walled carbon nanotubes,” Nano Lett 4 (3), 517-520 (2004).
¹⁹ Supriyo Datta, Electronic transport in mesoscopic systems. (Cambridge University Press, Cambridge; New York, 1995), pp. xv, 377 p.

1. A high frequency circuit comprising:
first and second electronic devices; and
a nanotube interconnect connecting the first and second devices, wherein the nanotube interconnect is capable of carrying current at high frequencies.

2. The high frequency circuit of claim 1, wherein the first device is configured to send electrical signals to the second device via the nanotube interconnect at high frequencies.

3. The high frequency circuit of claim 2, wherein the first device is configured to send electrical signals via the nanotube interconnect at frequencies of at least 0.8 GHz.

4. The high frequency circuit of claim 2, wherein the first device is configured to send electrical signals via the nanotube interconnect at frequencies of at least 2 GHz.

5. The high frequency circuit of claim 1, wherein the first and second devices each comprise a nanotube transistor.

6. The high frequency circuit of claim 1, wherein the nanotube interconnect comprises a metallic single-walled carbon nanotube (SWNT).

7. The high frequency circuit of claim 6, wherein the nanotube interconnect comprises more than one SWNT arranged in a parallel array.

8. The high frequency circuit of claim 6, wherein the nanotube interconnect does not comprise semiconducting nanotubes.

9. The high frequency circuit of claim 1, wherein the current is 25 μA or higher.

10. The high frequency circuit of claim 1, wherein the nanotube interconnect is capable of carrying current at frequencies of at least 1 MHz to 0.8 GHz.

11. The high frequency circuit of claim 1, wherein the nanotube interconnect is capable of carrying current at frequencies of at least 2 GHz.

12. The high frequency circuit of claim 1, wherein the nanotube interconnect is capable of carrying current at frequencies of at least 5 GHz.

13. The high frequency circuit of claim 1, wherein the nanotube interconnect is capable of carrying current at frequencies of at least 10 GHz.

14. The high frequency circuit of claim 1, wherein the circuit is a computer processor operating at a clock frequency of at least 1 GHz and the nanotube interconnect is capable of carrying current at frequencies of at least 1 GHz.

15. The high frequency circuit of claim 1, wherein the circuit is a computer processor operating at a clock frequency of at least 2 GHz and the nanotube interconnect is capable of carrying current at frequencies of at least 2 GHz.

16. The high frequency circuit of claim 1, wherein the circuit is a radio frequency (RF) circuit operating at a high frequency of at least 0.8 GHz.

17. A method comprising the steps of
coupling a power source to a high frequency circuit having nanotube interconnects, and
carrying current over the nanotube interconnects at high frequencies.

18. The method of claim 17, wherein the nanotube interconnects interconnect nanotube transistors.

19. The method of claim 17, wherein the nanotube interconnects comprise metallic single-walled carbon nanotubes (SWNTs).

20. The method of claim 17, wherein the nanotube interconnects do not comprise semiconducting nanotubes.

21. The method of claim 17, wherein the current is 25 μA or higher.

22. The method of claim 17, wherein the current is at a frequency of at least 1 MHz to 0.8 GHz.

23. The method of claim 17, wherein the current is at a frequency of at least 2 GHz.

24. The method of claim 17, wherein the current is at a frequency of at least 5 GHz.

25. The method of claim 17, wherein the current is at a frequency of at least 10 GHz.

26.-29. (canceled)
